(19) United States
(12) Patent Application Publication
(10) Pub. No.: US 2007/0278360 A1
(43) Pub. Date: Dec. 6, 2007

(54) Shelf Stand Assembly

(76) Inventor: Kuang-Ping Chen, Sindian City (TW)

Correspondence Address: ELIZABETH CHIEN-HALE, 40087 MISSION BLVD. BOX 367, FREMONT, CA, 94539, US

(21) Appl. No.: 11/422,067

(22) Filed: Jun. 3, 2006

(51) Int. Cl. F16L 3/00

(52) U.S. Cl. 248/121

(57) ABSTRACT

A shelf stand assembly has a shelf stand and at least one positioning assembly. The shelf stand has a side surface and a slot formed in the side surface. Each positioning assembly has two mounting tabs mounted in the slot slidably. People can place a containing element like a plate or a box between multiple sets of the shelf stand, and move the mounting tabs of each positioning assemblies along the slot to adjust position and clamp the containing elements, then use screws secures the mounting tabs. Since the position of the containing elements can be adjusted by moving the mounting tabs along the slot, so the shelf stand assembly is convenient to use. Furthermore, the containing element is clamped by the mounting tabs, so the containing element can be held more stable, whether the containing element become brittle after a long-term use.

### BACKGROUND OF THE INVENTION

1. Field of the Invention

The present invention relates to a shelf stand, and more particularly to a shelf stand assembly that is conveniently and stably to use.

2. Description of Related Art

Shelves are used widely in people's life. A shelf usually has multiple shelf stands that are typically mounted in the shelf to hold on a containing element like a plate or a box. A conventional shelf stand has an outer surface and comprises multiple mounting tabs and multiple screws.

The outer surface has a longitudinal axis.

The mounting tabs are mounted securely on the outer surface along the longitudinal axis. Each mounting tab has a surface defined perpendicularly to the outer surface of the shelf stand and typically has two mounting holes formed through the surface.

The screws pass through the mounting holes and screw into the containing element to hold on the containing element securely, such that people can put things in or on the containing element.

However, since the mounting tabs are mounted securely on the outer surface of the shelf stand, such that the position of the containing element cannot be adjusted, which causes inconvenience.

Moreover, because the containing element is held by the screws, so the containing element would possibly be unstable if the containing element become brittle after a long-term use.

To overcome the shortcomings, the present invention provides an improved shelf stand assembly to obviate or mitigate the aforementioned problems.

### SUMMARY OF THE INVENTION

The main objective of the invention is to provide a shelf stand assembly that is conveniently and stably to use.

The shelf stand assembly comprises a shelf stand and at least one positioning assembly.

The shelf stand has a side surface and a slot.

The slot is defined longitudinally in the side surface of the shelf stand and has an inner surface formed inside the slot.

Each one of the at least one positioning assembly comprises two mounting tabs. The mounting tabs are mounted slidably in the slot, can adjust position by move along the slot or move close to each other to clamp, and each mounting tab has multiple fastening screws to fix the mounting tab in position after adjustment.

People can place a containing element like a plate or a box between multiple sets of the shelf stand, and move the mounting tabs of each positioning assemblies along the slot to adjust position and clamp the containing element, then using screws secures the mounting tabs.

Since the position of the containing elements can be adjust by moving the mounting tabs along the slot, the shelf stand assembly of the present invention is more convenient to use. Furthermore, the containing element is clamped by the mounting tabs, so the containing element can be held more stable, whether the containing element become brittle after a long-term use.

### BRIEF DESCRIPTION OF THE DRAWINGS

FIG. 1 is a perspective view of a shelf stand in accordance with the present invention;

FIG. 2 is an exploded perspective view of the shelf stand in FIG. 1;

FIG. 3 is an enlarged exploded perspective view of a mounting tab of the shelf stand in FIG. 1;

FIG. 4 is an enlarged partial exploded perspective view of the mounting tab of the shelf stand in FIG. 1;

FIG. 5 is a perspective view of a plate and a box held by multiple sets of the shelf stands in FIG. 1;

FIG. 6 is a partial cross sectional side view of the box in FIG. 5; and

FIG. 7 is a partial cross sectional side view of the plate in FIG. 5.

### DETAILED DESCRIPTION OF THE PREFERRED EMBODIMENT

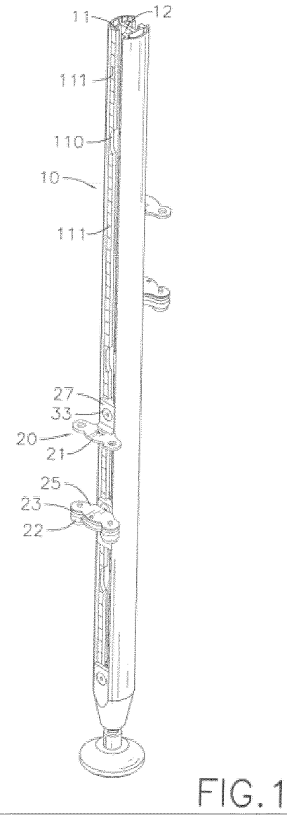

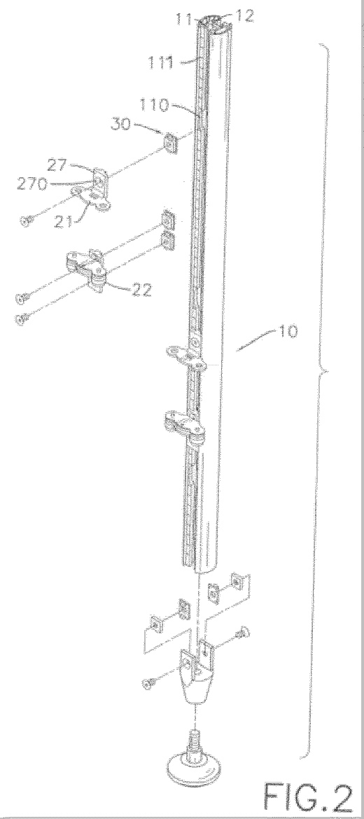

With reference to FIGS. 1 and 2, a shelf stand assembly in accordance with the present invention comprises a shelf stand (10) and at least one positioning assembly (20).

The shelf stand (10) has two side surfaces and at least one slot (12). Each slot (12) is defined longitudinally in each side surface of the shelf stand (10) and has an inner surface, two opposite sidewalls and two ribs (11) are formed along the sidewalls. Each rib (11) has an outside surface, multiple openings (110) and multiple optional scales (111). The openings (110) are separately formed longitudinally in the ribs (11). The scale (111) are formed on the outside surface of each rib (11).

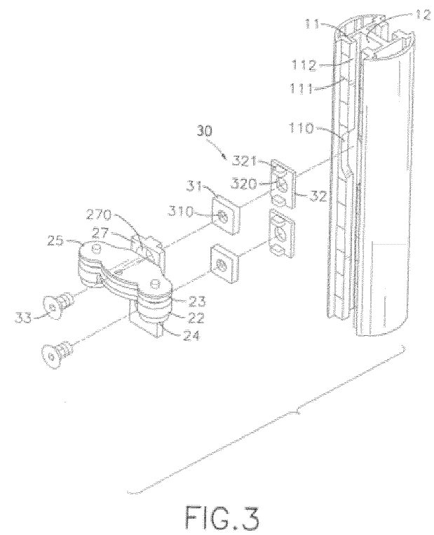

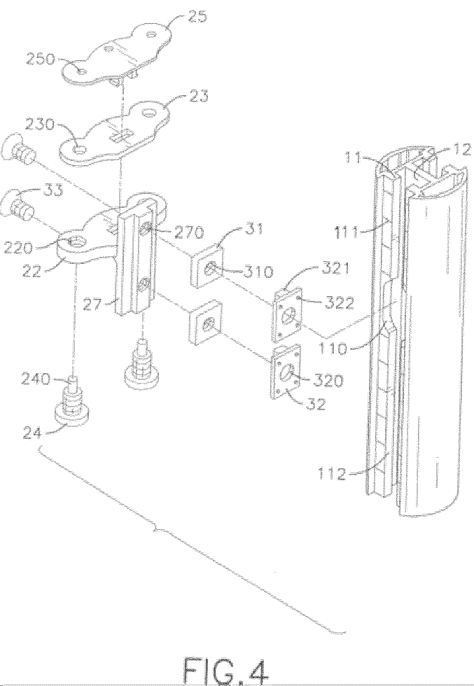

With further reference to FIGS. 3 and 4, each one of the at least one positioning assembly (20) comprises a secondary mounting tab (21), a primary mounting tab (22), multiple mounting brackets (30), a spacer (25), an optional pad (23), at least two mounting screws (24) and multiple fastening screws (33).

The mounting tabs (21)(22) are opposite to each other. Each mounting tab (21)(22) has a mounting surface defined perpendicularly to the side surface of the shelf stand (10) and has a side, a mounting portion (27) and at least two mounting holes (220). The mounting portion (27) is formed on the side of the primary tab (22) and are perpendicular to the mounting surface of the primary tab (22) and are parallel to the inner surface of the slot (12) in the shelf stand (10) and has multiple threaded holes (270). The threaded holes (270) are formed in the mounting portion (27) corresponding to the inner surface of the secondary and primary mounting tabs (21)(22) and has optional inner threads.

The mounting brackets (30) are mounted slidably in the slot (12) from the openings (110). Each mounting bracket (30) comprises a stage (32) and a fixing element (31). The stage (32) and the fixing element (31) can be integrally formed as a single piece. The stage (32) has a contact surface, a front surface, a through hole (320), multiple resilient protrusions (322) and two optional holding protrusions (321). The contacting surface faces the inner surface of the slot (12). The resilient protrusions (322) are formed on the contact surface to rub against the inner surface of the slot (12) to generate a friction for supporting the mounting bracket (30). The through hole (320) is formed in the stage (32). The holding protrusions (321) are formed oppositely on the front surface of the stage (32). The fixing element (31) is securely attached to the front surface of the stage (32) and has a threaded hole (310). The threaded hole (310) is formed through the fixing element (31), aligns with the through hole (320) in the stage (32) and corresponds to one of the threaded holes (270) in the mounting portion (27).

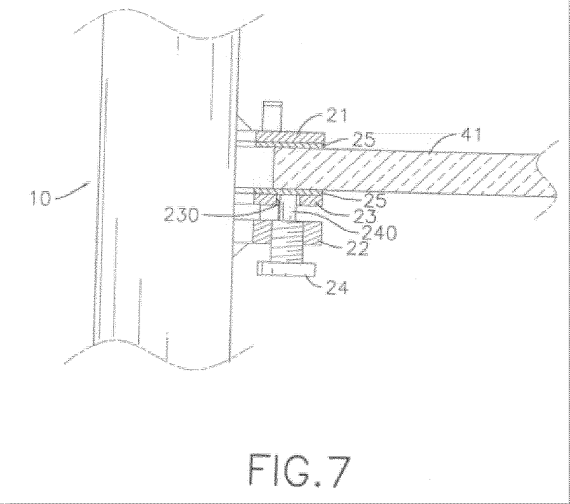

The spacer (25) has a flat surface and optionally have two apertures (250) or a flat bottom surface (with reference to FIG. 7). The apertures (250) are formed through the flat surface of the spacer (25) and respectively correspond to the mounting holes (220) in the primary mounting tab (22) and each has a diameter.

The pad (23) is mounted on the mounting surface of the primary mounting tab (22) and is connected with the spacer (25) by a connector to cushion the pressure on the spacer (25) and has at least two through holes (230). The through holes (230) are formed through the pad (23) and respectively correspond to the mounting holes (220) and each has a diameter.

The mounting screws (24) are mounted respectively through the mounting holes (220) in the primary tab (22). Each mounting screw (24) has a diameter, an end and a tip (240). The diameter of the mounting screw (24) is greater than the diameter of the through holes (230) in the pad (23) and the apertures (250) in the spacer (25). The tip (240) is formed in the end of the mounting screw (24), has a diameter small than the diameter of the through holes (230) in the pad (23).

The mounting screws (24) screw respectively into the mounting holes (220), and the tips (240) extend respectively through the through holes (230) in the pad (23) and may protrude into and out from the apertures (250) of the spacer (25) when the apertures (250) are defined in the spacer (25) or abut against the flat bottom surface of the spacer (25) when no aperture (250) is defined in the spacer (25).

The fastening screws (33) are screwed into the threaded holes (270) in the mounting portion (27) and the threaded holes (310) in the fixing element (31) and optionally extend into the through holes (320) in the stages (32). Therefore, the mounting portion (27) and the mounting bracket (30) clamp the rib (11) tightly to securely hold the mounting brackets (30) and the mounting tabs (21)(22) in the slot (12).

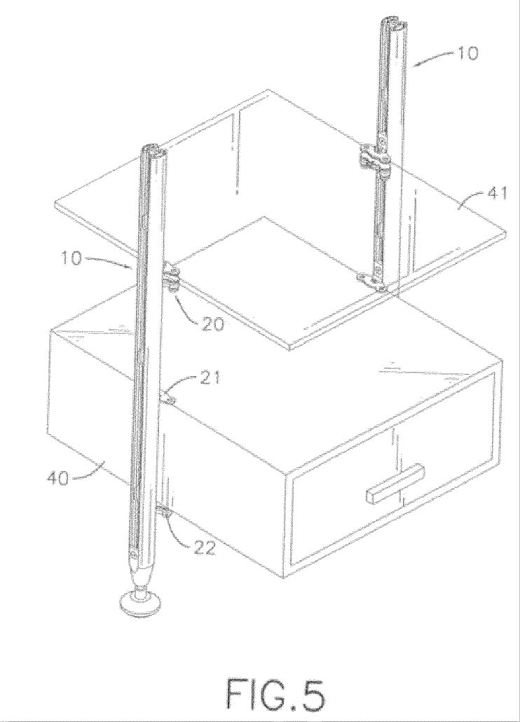

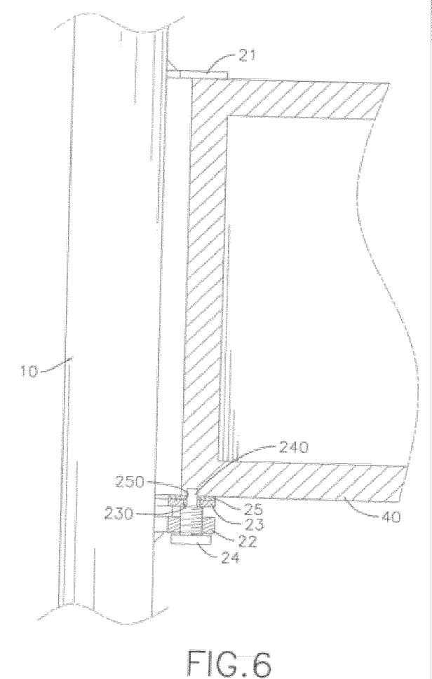

With further reference to FIGS. 5 and 6, containing elements such as a plate (41) and a box (40) respectively having a top surface and a bottom surface can be held by multiple sets of the shelf stand (10) of the present invention. The plate (41) and the box (40) are clamped respectively between the mounting tabs (21)(22) of a positioning assembly (20). The top surface and the bottom surface of the box are compressed by the mounting surfaces of the secondary mounting tab (21) and the flat surfaces of the spacers (25). The tips (240) of the mounting screws (24) insert into the bottom surface of the box (40) to keep the box (40) from slipping and dropping from the positioning assembly (20).

With further reference to FIG. 7, the top surface and the bottom surface of the plate (41) are compressed by the mounting surfaces of the mounting tabs (21)(22) and the flat surfaces of the spacers (25). When the mounting screws (24) are screwed into the mounting holes (220), the tip (240) of the mounting screws (24) may push against the flat bottom surface of the spacer (25) and make the spacer (25) moving upward to compress the plate (41) tightly in cooperation with the mounting surface of the secondary mounting tab (21) and hold the plate (41) in stable.

Since the position of the containing element can be adjusted by moving the mounting tabs (21)(22) along the slot (12), the shelf stand (10) of the present invention is more convenient to use.

Furthermore, the containing element is clamped by the mounting tabs (21)(22) so the containing element can be held more stable, whether the containing element become brittle after a long-term use.

Additionally, the multiple openings (110) are formed separately along the ribs (11) so people can select a suitable opening (110) to put in the mounting bracket (30) when the shelf stand (10) is set on the ground. The scale (111) in the surface of each rib (11) can help people to adjust the level of the containing element. The friction generated by the resilient protrusions (322) rubbing against the inner surface of the slot (12) can help to retain the mounting tabs (21)(22) before being held, such that people have no need to keep hold the mounting tabs (21)(22). Above said advantage make the shelf stand in accordance with present invention be able to provide more convenience to people.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A shelf stand assembly comprising:
a shelf stand having
at least one side surface; and
at least one slot being defined longitudinally in the at least one side surface of the shelf stand and each at least one slot having
an inner surface;
two sidewalls being perpendicular to the inner surface; and
two ribs being formed along the sidewalls, and each rib having an outside surface; and
at least one positioning assembly, each one comprising
a secondary mounting tab having
a side;
a mounting surface defined perpendicularly to the at least one side surface of the shelf stand; and
a mounting portion formed on the side of the secondary mounting tab being parallel to the inner surface of a corresponding slot in the shelf stand and having a threaded hole formed in the mounting portion of the secondary mounting tab;
a primary mounting tab being opposite to the secondary mounting tab and having
a side;
a mounting surface defined perpendicularly to the at least one side surface of the shelf stand; and
a mounting portion formed on the side of the primary mounting tab being parallel to the inner surface of a corresponding slot in the shelf stand and having at least two threaded holes formed in the mounting portion;
a mounting surface being defined perpendicularly to the at least one side surface of the shelf stand; and
at least two mounting hole being formed through the mounting surface of the primary mounting tab and having inner threads;
a spacer mounted on the mounting surface of the primary mounting tab and having a flat surface and a flat bottom surface;
at least two mounting screws being mounted respectively through the mounting holes in the primary mounting tab, and each mounting screw having
a diameter; and
an end; and
multiple mounting brackets being mounted slidably in the at least one slot in the shelf stand, and each mounting bracket corresponding to one of the primary mounting tab and the secondary mounting tab and comprising
a fixing element having a threaded hole formed through the fixing element;
multiple fastening screws screwing respectively through the threaded holes in the mounting portions of the primary mounting tab and the secondary mounting tab and respectively into the threaded holes in the fixing elements of the multiple mounting brackets to make the mounting tabs clamping the ribs on a corresponding slot tightly in cooperation with the fixing elements of the mounting brackets.

2. The shelf stand assembly as claimed in claim 1, wherein each mounting bracket of each one of the at least one positioning assembly further comprise
a stage having
a contact surface facing the inner surface of a corresponding one of the at least one slot;
a front surface being securely attached with a corresponding fixing element;
a through hole formed through the stage aligning with the threaded hole of the corresponding fixing element and corresponding to a corresponding threaded hole in the mounting portion of a corresponding mounting tab; and multiple resilient protrusions being formed on the contact surface to rub against the inner surface of the corresponding slot.

3. The shelf stand assembly as claimed in claim 2, wherein each mounting screw of each one of the at least one positioning assembly further comprises a tip with a diameter being formed on the end of the mounting screw; and
the spacer of each one of the at least one positioning assembly further has at least two apertures holding respectively the tips of corresponding mounting screws, being formed respectively through the flat surface and corresponding to the mounting holes in the primary mounting tab and having a diameter being smaller than the diameter of the mounting screws and being greater than the diameter of the corresponding tips.

4. The shelf stand assembly as claimed in claim 3, wherein each one of the at least one positioning assembly further comprises a pad mounted between the primary mounting tab and the spacer of the positioning assembly and having
at least two through holes holding respectively the tips on corresponding mounting screws, formed through the pad and being corresponding to the mounting holes respectively and each through hole having a diameter being smaller than the diameter of the mounting screws and larger than the diameter of the tips.

5. The shelf stand assembly as claimed in claim 4, wherein the tips of the at least tow mounting screws of each one of the at least one positioning assembly extend respectively through the through holes in a corresponding pad and protrude respectively into the apertures of a corresponding spacer

6. The shelf stand assembly as claimed in claim 5, wherein each of the ribs of the shelf stand further has multiple openings being separately formed longitudinally in the rib.

7. The shelf stand assembly as claimed in claim 6, wherein each of the ribs of the shelf stand further has multiple scales being formed on the outside surface of the rib.
